(19) United States
(12) Patent Application Publication
(10) Pub. No.: US 2026/0051419 A1
(43) Pub. Date: Feb. 19, 2026

(54) SYSTEM AND METHOD FOR QUANTUM NON-DEMOLITION PHOTON COUNTING USING A RYDBERG ATOM ARRAY

(71) Applicants: University of Maryland, College Park, College Park, MD (US); Government of the United States of America, as Represented by the Secretary of Commerce, Gaithersburg, MD (US)

(72) Inventors: Alexey Gorshkov, Potomac, MD (US); Michael J. Gullans, Potomac, MD (US); James V. Porto, Arlington, VA (US); Kunal Sharma, Yorktown Heights, NY (US); Christopher Fechisin, Silver Spring, MD (US); Przemyslaw Bienias, San Francisco, CA (US); Steven Lloyd Rolston, Hyattsville, MD (US)

(21) Appl. No.: 18/806,265

(22) Filed: Aug. 15, 2024

Related U.S. Application Data
(60) Provisional application No. 63/520,087, filed on Aug. 16, 2023.

(51) Int. Cl. G21K 1/00

(52) U.S. Cl. CPC G21K 1/006

(57) ABSTRACT

A quantum non-demolition photon counter includes a quantum system, a processor, and a memory. The quantum system includes photons. The memory includes instructions stored thereon, which, when executed by the processor, cause the system to: couple an initial photonic state of the quantum system to an array of atoms in a |g [symbol] -|e [symbol] transition; store the photon(s) in the array using a classical control field acting on the |s [symbol] -|e [symbol] transition; oscillate the array between the states |s [symbol] and |r [symbol] , where |r [symbol] is a Rydberg state; and perform a projective measurement of a presence of a Rydberg excitation by indirectly and progressively measuring a photon number n by directly and repeatedly measuring the presence of the Rydberg excitation after under Ĥ for a predetermined period of time. The array of atoms is initially in a ground state |g [symbol] and |e [symbol] is an excited state.

### CROSS-REFERENCE TO RELATED APPLICATION/CLAIM OF PRIORITY

This application claims the benefit of, and priority to, U.S. Provisional Patent Application No. 63/520,087 filed on Aug. 16, 2023, the entire contents of which are hereby incorporated herein by reference.

### GOVERNMENT SUPPORT

This invention was made with government support under 70NANB21H126 awarded by the National Institute of Standards and Technology and FA95501910275 awarded by the Air Force Office of Scientific Research. The government has certain rights in the invention.

### TECHNICAL FIELD

The present disclosure relates generally to quantum computing and operations, including quantum devices. More specifically, the present disclosure provides, for example, a system and method for quantum non-demolition photon counting using a Rydberg atom array.

### BACKGROUND

In the field of quantum computing, quantum photon counting enables precise detection of single photons, which are fundamental carriers of quantum information. This high sensitivity is used for accurate quantum state measurements and error correction in quantum algorithms. Quantum photon counting is often destructive to photons because the process typically involves absorbing the photon to register its presence, thereby annihilating it. Detectors like photomultiplier tubes or avalanche photodiodes operate by converting the photon's energy into an electrical signal, which means the photon is no longer available after detection. This destruction is inherent to many photon counting techniques, making it challenging to reuse the same photons for subsequent measurements.

Accordingly, there is interest in quantum non-demolition photon counting.

### SUMMARY

In an aspect of the present disclosure, a system for quantum non-demolition photon counting is presented. The system includes a quantum system, a processor, and a memory. The quantum system includes photons. The memory includes instructions stored thereon, which, when executed by the processor, cause the system to: store photon(s) in an array of atoms of the quantum system using a classical control field acting on an |s [symbol] -|e [symbol] transition, wherein |s [symbol] is a metastable shelving state and |e [symbol] is an excited state, wherein the array of atoms is initially in a ground state |g [symbol] ; oscillate the array between the states |s [symbol] and |r [symbol] , where |r [symbol] is a Rydberg state; and perform a projective measurement of a presence of a Rydberg excitation by indirectly and progressively measuring a photon number n by directly and repeatedly measuring the presence of the Rydberg excitation after evolution under Ĥ for a predetermined period of time. The array of atoms is initially in a ground state |g [symbol] and |e [symbol] is an excited state. The coupling is performed by sending the initial photonic state through a beamsplitter so that the initial photonic state is normally incident upon the array symmetrically from both sides.

In another aspect of the present disclosure, the array may be a Rydberg array. The atoms may be in an ordered, uniform, equally spaced-out lattice.

In an aspect of the present disclosure, the projective measurements project the array into a subspace with or without a Rydberg excitation in |r [symbol] , conditioned on the outcome of the measurement.

In another aspect of the present disclosure, the instructions, when executed by the processor, may further cause the system to provide an excitation to put atoms of the array in an intermediate state.

In an aspect of the present disclosure, the oscillations are driven by a laser.

In another aspect of the present disclosure, the instructions, when executed by the processor, may further cause the system to determine the photon number n based on increasing the oscillation frequency from a first frequency to a second frequency.

In an aspect of the present disclosure, the instructions, when executed by the processor, may further cause the system to send the initial photonic state through a beamsplitter so that the the initial photonic state is normally incident upon the array symmetrically from both sides.

In another aspect of the present disclosure, the instructions, when executed by the processor, may further cause the system to: retrieve the stored photons, wherein the array must be in the state |Sₙ [symbol] to retrieve the photons.

In an aspect of the present disclosure, the measurement may be performed by tuning to electronically induced transparency (EIT) and applying a weak classical probe light. The instructions, when executed by the processor, may further cause the system to: apply EIT to the array in the Rydberg state; applying a classical probe light at the array; and determine if the array is transparent. In the absence of a Rydberg excitation, an EIT condition may be satisfied and the array is transmissive. In the presence of the Rydberg excitation the EIT condition may be disrupted and the array may be reflective.

An aspect of the present disclosure provides a method for quantum non-demolition photon counting includes: store photon(s) in an array of atoms of the quantum system using a classical control field acting on an |s [symbol] -|e [symbol] transition, wherein |s [symbol] is a metastable shelving state and |e [symbol] is an excited state, wherein the array of atoms is initially in a ground state |g [symbol] ; oscillating the array between the states |s [symbol] and |r [symbol] , wherein |r [symbol] is a Rydberg state; and performing a projective measurement of a presence of a Rydberg excitation by indirectly and progressively measuring a photon number n by directly and repeatedly measuring the presence of the Rydberg excitation after evolution under Ĥ for a predetermined period of time.

In an aspect of the present disclosure, the array may be a Rydberg array. The atoms may be in an ordered, uniform, equally spaced-out lattice.

In another aspect of the present disclosure, the projective measurements may project the array into a subspace with or without a Rydberg excitation in |r [symbol] , conditioned on the outcome of the measurement.

In an aspect of the present disclosure, the method may further include providing an excitation to put atoms of the array in an intermediate state.

In an aspect of the present disclosure, only the atoms that have absorbed photons may be addressed by driving the atoms that have absorbed photons to a Rydberg state.

In another aspect of the present disclosure, the method may further include determining the photon number n based on increasing the oscillation frequency from a first frequency to a second frequency.

In another aspect of the present disclosure, the method may further include sending the initial photonic state through a beamsplitter so that the initial photonic state is normally incident upon the array symmetrically from both sides.

In another aspect of the present disclosure, the method may further include retrieving the stored photons, wherein the array must be in the state (Sₙ [symbol] to retrieve the photons.

In an aspect of the present disclosure, the measurement may be performed by tuning to electronically induced transparency (EIT) and applying a weak classical probe light. The method may further include: applying EIT to the array in the Rydberg state; applying a classical probe light at the array; and determining if the array is transparent. In the absence of a Rydberg excitation, an EIT condition is satisfied and the array is transmissive. In the presence of the Rydberg excitation the EIT condition is disrupted and the array is reflective.

An aspect of the present disclosure provides a non-transitory computer-readable medium storing instructions which, when executed by a processor, cause the processor to perform a computer-implemented method for quantum non-demolition photon counting. The method includes: storing photon(s) in an array of atoms of the quantum system using a classical control field acting on an |s [symbol] -|e [symbol] transition, wherein |s [symbol] is a metastable shelving state and |e [symbol] is an excited state, wherein the array of atoms is initially in a ground state |g [symbol] ; oscillating the array between the states |s [symbol] and |r [symbol] , wherein |r [symbol] is a Rydberg state; and performing a projective measurement of a presence of a Rydberg excitation by indirectly and progressively measuring a photon number n by directly and repeatedly measuring the presence of the Rydberg excitation after evolution under Ĥ for a predetermined period of time. The array of atoms is initially in a ground state |g [symbol] , and |e [symbol] is an excited state. The coupling is performed by sending the initial photonic state through a beamsplitter so that the initial photonic state is normally incident upon the array symmetrically from both sides. |s [symbol] is a metastable shelving state.

Further details and aspects of exemplary aspects of the present disclosure are described in more detail below with reference to the appended drawings.

### BRIEF DESCRIPTION OF THE DRAWINGS

A better understanding of the features and advantages of the present disclosure will be obtained by reference to the following detailed description that sets forth illustrative aspects, in which the principles of the present disclosure are utilized, and the accompanying drawings of which:

FIG. 1 is a diagram of an exemplary system for quantum non-demolition photon counting, in accordance with examples of the present disclosure;

FIG. 2 is a block diagram of a controller configured for use with the system of FIG. 1, in accordance with aspects of the present disclosure;

FIG. 3 is a diagram illustrating a level structure of an array of atoms for use with the system of FIG. 1, in accordance with aspects of the present disclosure;

FIG. 4 is a flow diagram of the stages of a method for quantum non-demolition photon counting using the system of FIG. 1, in accordance with aspects of the present disclosure;

FIG. 5 is a flow diagram of a method for quantum non-demolition photon counting using the system of FIG. 1, in accordance with aspects of the present disclosure;

FIG. 6 is a diagram illustrating populations in Ryberg and no Ryberg sectors as a function of time, in accordance with aspects the present disclosure;

FIG. 7 is a diagram illustrating state inference as a function of observation cycle, in accordance with aspects of the present disclosure;

FIG. 8 is a diagram illustrating Ryberg populations of various n during the first observation cycle, in accordance with aspects of the present disclosure;

FIG. 9 is a diagram illustrating Rydberg oscillation dynamics in the presence of varying noise levels, in accordance with aspects of the present disclosure;

FIG. 10 is a diagram of the Hamiltonian superoperator [symbol] in matrix form, in accordance with aspects of the present disclosure; and

FIG. 11 is a diagram of [symbol] in matrix form, in accordance with aspects of the present disclosure.

### DETAILED DESCRIPTION

The present disclosure relates generally to quantum computing and operations, including quantum devices. More specifically, the present disclosure provides, for example, a system and method for quantum non-demolition photon counting using a 2D Rydberg atom array.

Aspects of the present disclosure are described in detail with reference to the drawings wherein like reference numerals identify similar or identical elements.

Although the present disclosure will be described in terms of specific examples, it will be readily apparent to those skilled in this art that various modifications, rearrangements, and substitutions may be made without departing from the spirit of the present disclosure. The scope of the present disclosure is defined by the claims appended hereto.

For the purpose of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the novel features illustrated herein, and any additional applications of the principles of the present disclosure as illustrated herein, which would occur to one skilled in the relevant art and having possession of this disclosure, are to be considered within the scope of the present disclosure.

Photon counting is most simply performed by capturing photons with a detector which converts each photon to an electrical signal, but this process destroys the quantum state of the photons. The disclosed systems and methods of quantum non-demolition (QND) photon counting circumvent this issue in various ways, preserving the quantum state of the photons after the measurement. This is ideal for applications like quantum networking and state preparation which make further use of the photonic state after the measurement.

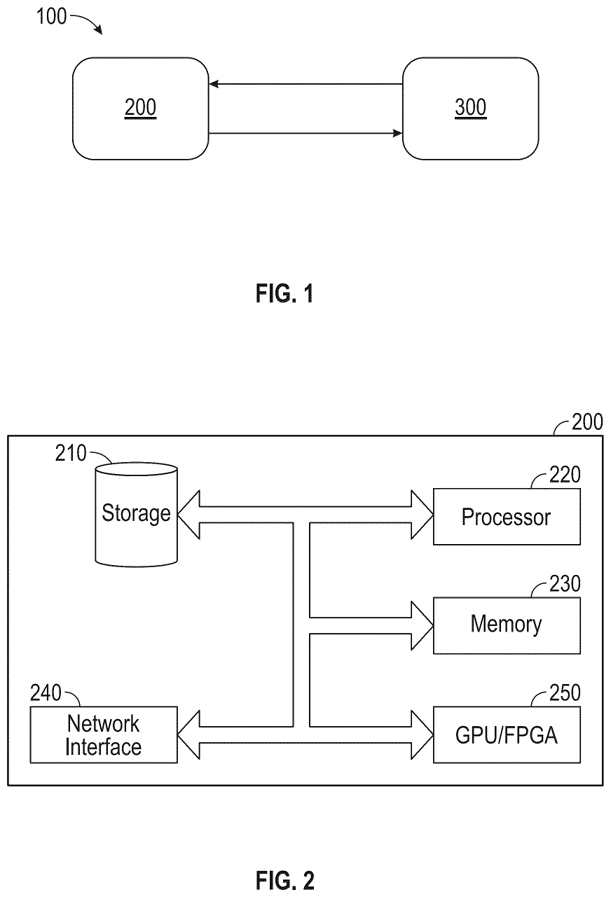

Referring to FIG. 1, a diagram of an exemplary QND photon counter 100, in accordance with the present disclosure, is shown. The quantum non-demolition photon counter 100 generally includes a quantum computing system 300, and a controller 200. The quantum computing system 300 includes one or more qubits (e.g., photons).

Rather than directly measuring the photon number n of the quantum system, a series of weak measurements via projective measurement of an alternative observable which is more readily accessible experimentally may be made. Many weak measurements performed sequentially can progressively collapse the system into an eigenstate of the photon number with high fidelity. So long as the series of weak measurements does not destroy the quantum coherence of the photons, it serves as an effective QND measurement of the photon number.

Methods for QND photon counting have been studied in a wide variety of experimental platforms, including cold atomic gases, microwave cavities, optical cavities, superconducting circuits, waveguides, and nonlinear metamaterials. These proposals each carry drawbacks and advantages relative to one another and can be ideal in different situations. Protocols that encode photon numbers in a phase, for instance, are well-suited for resolving small photon numbers but are only well-defined within a single period of the phase. Some proposals approach the task of non-destructively counting itinerant photons, while others require confinement to a cavity. The quantum non-demolition photon counter 100 of FIG. 1 described herein has no fundamental limitation in discerning large or small photon numbers and is able to count itinerant photons by storing them in a Rydberg array in free space.

Rydberg atoms, due to their intrinsic controllability and strong dipole-dipole and van der Waals interactions, have become a prototypical system for facilitating interactions between photons and empowered by the development of Rydberg arrays, simulating many-body physics. The quantum optical properties of disordered ensembles of Rydberg atoms are well-known, but the quantum optics of ordered Rydberg arrays are less well-understood and have been the subject of much recent theoretical and experimental work. Ordered atomic arrays have been shown to exhibit emergent behaviors arising from cooperative interactions, such as acting as near-perfect mirrors, emitting light in fixed, geometrically determined directions, and storing light with significantly increased fidelity. Rydberg arrays combine these collective phenomena with strong optical nonlinearities, making for a powerful platform for the realization of photonic many-body physics and QND photon counting.

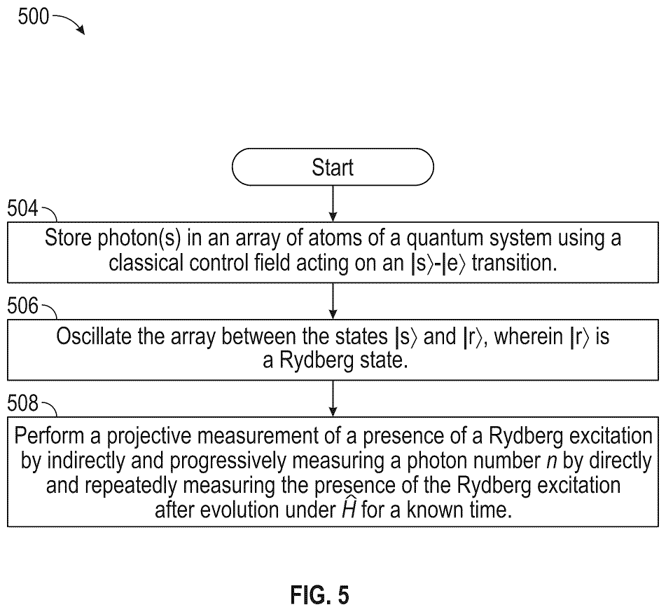

Referring to FIG. 2, a controller 200 is shown. The controller 200 generally includes a processor 220 and a memory 230, including instructions stored thereon, which, when executed by the processor 220, cause the quantum computing system 100 to perform the steps of method 500 of FIG. 5.

The processor 220 may be connected to a computer-readable storage medium 210 or a memory 230. The computer-readable storage medium or memory 230 may be a volatile type of memory, e.g., RAM, or a non-volatile type of memory, e.g., flash media, disk media, etc. In various aspects of the disclosure, the processor 220 may be any type of processor such as a quantum processor, a digital signal processor, a microprocessor, an application-specific integrated circuit (ASIC), a graphics processing unit (GPU) 250, a field-programmable gate array (FPGA), or a central processing unit (CPU).

In aspects of the disclosure, the memory 230 can be a quantum memory, random access memory, read-only memory, magnetic disk memory, solid-state memory, optical disc memory, and/or another type of memory. In some aspects of the disclosure, the memory 230 can be separate from the processor and can communicate with the processor wirelessly, or through communication buses of a circuit board and/or through communication cables such as serial ATA cables or other types of cables. The memory 230 includes computer-readable instructions that are executable by the processor 220 to operate the processor. In other aspects of the disclosure, the system 200 may include a network interface to communicate with other computers or to a server. A storage device may be used for storing data.

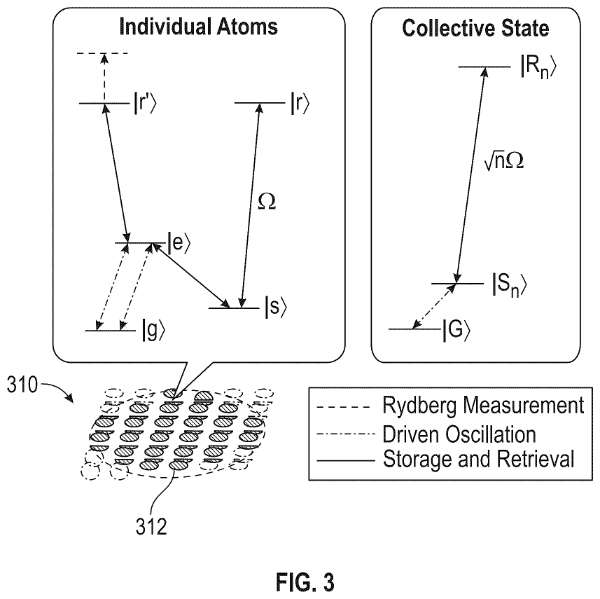

Referring to FIG. 3, a diagram illustrating a level structure of an array 310 of atoms 312 for use with the system of FIG. 1 is shown. The level structure of each atom 312 in the array 310, as well as the collective state of the array 310 is illustrated. The dashed line indicates the shift in the Rydberg level due to the presence of a Rydberg excitation. The shift in the Rydberg level disrupts an electronically induced transparency (EIT) condition by pushing the excited state to Rydberg excitation transition far off resonance, making the quantum system 300 fully reflective in the presence of a Rydberg excitation.

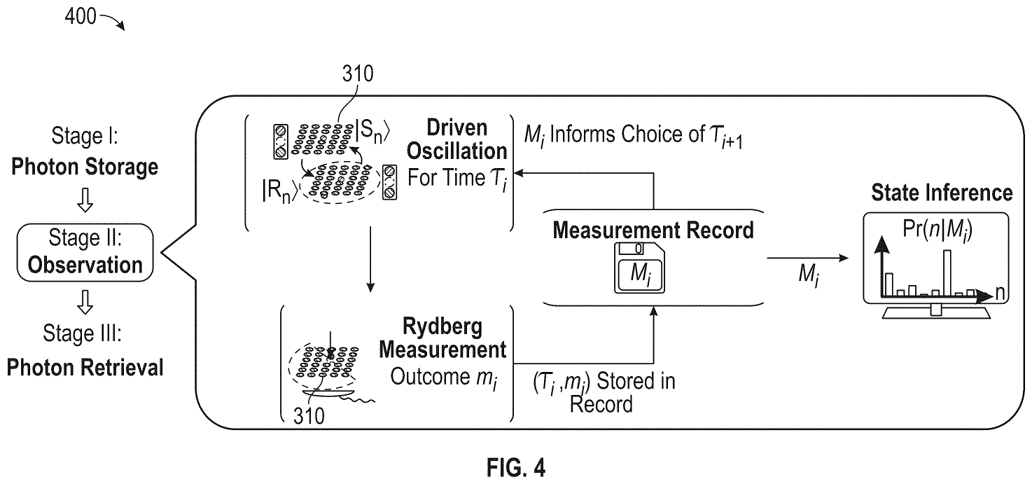

Referring to FIG. 4, a flow diagram of the stages 400 of a method for quantum non-demolition photon counting using the system of FIG. 1 is shown. The quantum non-demolition photon counter 100 of FIG. 1 may consist of three stages: (I) storing a photonic pulse in the array, (II) measuring the number of photons n contained therein, and (III) retrieving the stored pulse. The photon number is progressively pinned down through a series of observation cycles, each of which consists of a partial Rabi flop to a Rydberg spin wave state followed by a direct measurement of the presence of a Rydberg excitation. The frequency of the Rabi flop is enhanced by a factor of \sqrt{n} from the single-atom Rabi frequency, making it possible to discern arbitrary n. The outcome of the Rydberg measurement along with the known evolution time thus serves as a weak measurement of photon number n.

In the absence of dephasing noise during the observation stage, QND detection of n photons can be performed with fidelity limited only by storage and retrieval error in time t_{γ=0} about \sqrt{n}/Ω, where Ω is the single atom Rabi frequency and γ is the dephasing rate. In the presence of dephasing noise, the detection is no longer completely non-demolition and takes time t_{γ>0}˜γn/Ω.

An ordered two-dimensional array of atoms with subwavelength spacing was considered (e.g., a Rydberg array), where each atom has the level structure shown in FIG. 3. Lowercase letters label single-atom states, while uppercase letters label collective states of the many-body system. In particular, |g [symbol] is a ground state, |e [symbol] is an excited state, |s [symbol] is a metastable shelving state, and |r [symbol] and |r′ [symbol] are Rydberg states. In the context of a Rydberg array, the ground state refers to the lowest energy state of the system. A Rydberg array is a system of atoms, typically arranged in a regular lattice, where each atom can be excited to a high-energy Rydberg state (a state with a high principal quantum number).

|G [symbol] is the many-body ground state in which all atoms are in the state |g [symbol] . |Sₙ [symbol] is the symmetrized collective state with n excitations of individual atoms to |s [symbol] :

$$\vert {S}_{n} 〉 = \frac{1}{\sqrt{{N}^{{C}_{n}}}} {\sum }_{{i}_{j} = 1}^{N} {\hat{σ}}_{sg}^{( {i}_{1} )} … {\hat{σ}}_{sg}^{( {i}_{n} )} \vert G 〉 ,$$

where \hat{δ}ᵢⱼ:=|i [symbol] [symbol] j|. Similarly, |Rₙ [symbol] is the symmetrized spin wave state with n-1 atoms excited to |s [symbol] and one atom excited to the Rydberg state

$$\vert r 〉 : \vert {R}_{n} 〉 = \frac{1}{\sqrt{n}} {\sum }_{i = 1}^{N} {\hat{σ}}_{rs}^{( i )} \vert {S}_{n} 〉 .$$

It is assumed that the entire array is within a blockade radius, so that further excitations to |r [symbol] are forbidden by the blockade.

In Stage I, an initial photonic state couples to the |g [symbol] -|e [symbol] transition and is stored in the array using an auxiliary classical control field acting on the |s [symbol] -|e [symbol] transition. Coupling an initial photonic state typically refers to the process of transferring or interfacing the quantum state of photons with another system, such as the array of atoms. For example, to couple the initial photonic state to an atomic array, the initial photonic state is sent through a beamsplitter so that the initial photonic state is normally incident upon the array symmetrically from both sides. The photonic state is denoted as a superposition of number states |n [symbol] ,

$$\vert {ψ}_{ph} 〉 = {\sum }_{i = 1}^{N} {c}_{n} \vert n 〉 .$$

N is the number of atoms in the array and therefore the upper bound on the number of excitations which can be stored in the array. Photon storage is performed on the |g [symbol] -|e [symbol] -|s [symbol] . Storage maps the state of the array from |G [symbol] to Σₙcₙ|Sₙ [symbol] , where the amplitudes cₙ are inherited from |ψ_{S} [symbol] . Each photon is therefore stored as an excitation from |g [symbol] to |s [symbol] .

Stage II generally consists of two operations on the collective state: (1) Rabi flops (i.e., oscillations) between the states |s [symbol] and |r [symbol] and (2) projective measurement of the presence of a Rydberg excitation (see FIG. 4). Rabi flops refer to the periodic oscillations in the population of quantum states of a two-level system when it interacts with a coherent oscillating electromagnetic field, such as a laser. To drive the collective oscillation, |sᵢ [symbol] was coupled to the Rydberg state |rᵢ [symbol] via the rotating frame Hamiltonian

$$\hat{H} = Ω {\sum }_{i = 1}^{N} {\hat{σ}}_{rs}^{( i )} + h . c . ,$$

where Ω is the Rabi frequency of the transition and the sum is over all atoms in the array. This induces a coupling between the collective states |Sₙ [symbol] and |Rₙ [symbol] which depends explicitly on the number of stored photons n: [symbol] Sₙ|Ĥ|Rₙ)=\sqrt{n}Ω==:Ωₙ. The objective of this stage is to indirectly and progressively measure the photon number n by directly and repeatedly measuring the presence of a Rydberg excitation after evolution under Ĥ for some known time. Each observation cycle consists of a driven oscillation for time τᵢ and a projective measurement of the collective state yielding the measurement outcome mᵢ ∈ {Rydberg, no Rydberg}, building over time a measurement record through cycle T denoted M_{T}={(τᵢ, mᵢ)}_{i=1 . . . ,T}.

The measurements project the array into the subspace with or without a Rydberg excitation in |r [symbol] , conditioned on the outcome of the measurement. The measurement may be performed by tuning to electronically induced transparency (EIT) and applying a weak classical probe light. EIT is applied to the |g [symbol] -|e [symbol] -|r′ [symbol] subsystem, with the |s [symbol] -|r [symbol] subsystem acting as a switch. Thus, in the absence of a Rydberg excitation, the EIT condition is satisfied, and the array is transmissive, but in the presence of a Rydberg excitation, the EIT condition is disrupted, and the array is once again near-perfectly reflective. This measurement takes a finite amount of time which is limited by the width of the EIT transparency window.

Stage III consists of the retrieval of the stored photons. Assuming that the measured photon number was n, the array must be in the state |Sₙ [symbol] to retrieve the photons. If the preceding measurement instead projected the state to |Rₙ [symbol] , simply drive for time τ=π/2Ωₙ and arrive at |Sₙ [symbol] , so long as the measurement has converged to n. Retrieval can then be performed. The final photonic state comes out symmetrically from both sides of the array and can be combined onto a single path using a beamsplitter.

The measurement dynamics of the quantum system 300 during Stage II determines the quantum non-demolition photon counter's capabilities and effectiveness.

The dynamics under driving are described by the following Hamiltonian written in the basis of collective excitations: Ĥ_{coll}=ΣₙΩₙ (|Rₙ [symbol] [symbol] Sₙ|+|Sₙ [symbol] [symbol] Rₙ|. Beginning with state |ψ(0) [symbol] =Σₙcₙ|Sₙ [symbol] with amplitudes cₙ inherited from the stored light pulse. Driving under Ĥ_{coll} for time τ yields |ψ(τ) [symbol] =ΣₙCₙ(cos (Ωₙτ)|Sₙ [symbol] −isin (Ωₙτ)|Rₙ [symbol] ). Performing the Rydberg measurement as described above results in two possible outcomes:

$$\vert {ψ}_{S} 〉 = \frac{1}{{p}_{S}} {\sum }_{n} {c}_{n} cos ( {Ω}_{n} τ ) \vert {S}_{n} 〉 or \vert {ψ}_{R} 〉 = \frac{1}{{p}_{R}} {\sum }_{n} {c}_{n} sin ( {Ω}_{n} τ ) \vert {R}_{n} 〉 ,$$

with probabilities pₛ=Σₙ|cₙ cos(Ωₙτ)|² and p_{R}=Σₙ|cₙ sin(Ωₙτ)|². The amplitudes cₙ are therefore updated by a factor proportional to cos (Ωₙτ) or sin (Ωₙτ) as a result of the measurement, so that

$${c}_{n}^{( 1 )} ∼ {c}_{n} sin ( {Ω}_{n} τ ) or {c}_{n}^{( 1 )} ∼ {c}_{n} cos ( {Ω}_{n} τ ) ,$$

depending on the measurement outcome. This reflects the partial information learned about the photon number from a single measurement of the collective state.

After each measurement, the system is once again in a state of the form

$$\vert ψ 〉 = {\sum }_{n} {c}_{n}^{( i )} \vert {X}_{n} 〉 ,$$

where X ∈ {S, R}. Further iterations of unitary evolution and measurement will continue to update the amplitudes, so that after the i^{th} observational cycle the amplitudes are given by

$$\{ {c}_{n}^{( i )} \} .$$

For an arbitrary pure or mixed initial state, the state converges to a single photon number state as the quantum non-demolition photon counter 100 of FIG. 1 iterates, analogous to the progressive state collapse observed in, with the outcome always the distillation of a single photon number state.

The dynamics in this case are governed by the master equation \dot{ρ}(t)=−i[Ĥ_{coll}, ρ], under which the populations of ρ evolve independently of the coherences in the Fock basis. This implies that any two density matrices ρ and ρ′ which satisfy ρᵢᵢ(0)=ρ′ᵢᵢ(0) will also satisfy ρᵢᵢ(t)=p′ᵢᵢ(t). In particular, for any mixed state ρ(0) there exists some pure state ρ′(0) such that βᵢᵢ(0)=p′ᵢᵢ(0) and therefore ρᵢᵢ(t)=p′ᵢᵢ(t).

For example, an application of QND photon counting, as performed by the system 100 of FIG. 1, is state inference, which is the gleaning of information about the initial photonic state from the measurement record M_{T}={(τᵢ, mᵢ)}_{i=1, . . . ,T}.

Consider the set of distributions of photon number states with maximum photon number N, which is denoted {P_{α}}_{N}. Each distribution P_{α}=(p₀, . . . , p_{N})∈{P_{α}}_{N} describes a class of potential initial photonic states that share the same populations. Note that these classes are not discernable, as the quantum non-demolition photon counter 100 of FIG. 1 is insensitive to coherences between number states. Bayes' Theorem yields the probability that the initial state was described by P_{α}, conditioned on the measurement record M_{T}:

$$Pr ( {P}_{α} \vert {M}_{T} ) = \frac{Pr ( {M}_{T} \vert {P}_{α} ) Pr ( {P}_{α} )}{{\sum }_{α′} Pr ( {M}_{T} \vert {P}_{α ′} ) Pr ( {P}_{α ′} )} ,$$

where Pr(P_{α}) is a prior over the set of initial distributions. Pr(M_{T}|P_{α}) the quantity which must be computed to find Pr(P_{α}|M_{T}). Because different number states are not mixed through the quantum non-demolition photon counter 100 of FIG. 1, this expression can be written Pr(M_{T}|P_{α})=ΣₙpₙPr(M_{T}|n), where Pr(M_{T}|n) is the probability of observing the measurement record M_{T} given initial state |Sₙ [symbol] . This is readily given by Pr(M_{T}|n)=Π_{(τ}_{ᵢ}_{,m}_{ᵢ}_{)∈M}_{_{T}}Pr(mᵢ; tᵢ|n), where:

$$Pr ( {m}_{i} ; {t}_{i} \vert n ) = \{ \begin{matrix}cos {( {Ω}_{n} {τ}_{i} )}^{2} , & {m}_{i} = {m}_{i - 1} \\ sin {( {Ω}_{n} {τ}_{i} )}^{2} , & {m}_{i} \neq {m}_{i - 1}\end{matrix}$$

and m₀=no Rydberg.

Dephasing is a significant form of noise in Rydberg array experiments. Therefore, the quantum non-demolition photon counter 100 of FIG. 1 provides several improvements to performance under high dephasing noise. In particular, the evolution of the density matrix ρ(t) of the system under the master equation

$$\dot{ρ} ( t ) = - i [ \hat{H} , ρ ] + γ ( {\sum }_{i} {\hat{n}}_{i} ρ {\hat{n}}_{i} - \frac{1}{2} \{ {\hat{n}}_{i} , ρ \} ) ,$$

was examined, where the jump operators

$$\vert {r}_{i} 〉 〈 {r}_{i} \vert \text{=:} {\hat{n}}_{i} = {\hat{n}}_{i}^{†} = {\hat{n}}_{i}^{†} {\hat{n}}_{i}$$

represent dephasing on the state |r [symbol] at the ith atom.

This noise model can be understood as a continuous description of the process in which the environment measures where the Rydberg excitation is located within the spin wave, thereby removing the measured site from the coherent and symmetric superposition. Given enough time, such processes will remove all sites from the spin wave, resulting in a state which is entirely decohered. This is reflected in an exponential decay in the amplitude of the driven oscillation between |Sₙ [symbol] and |Rₙ [symbol] .

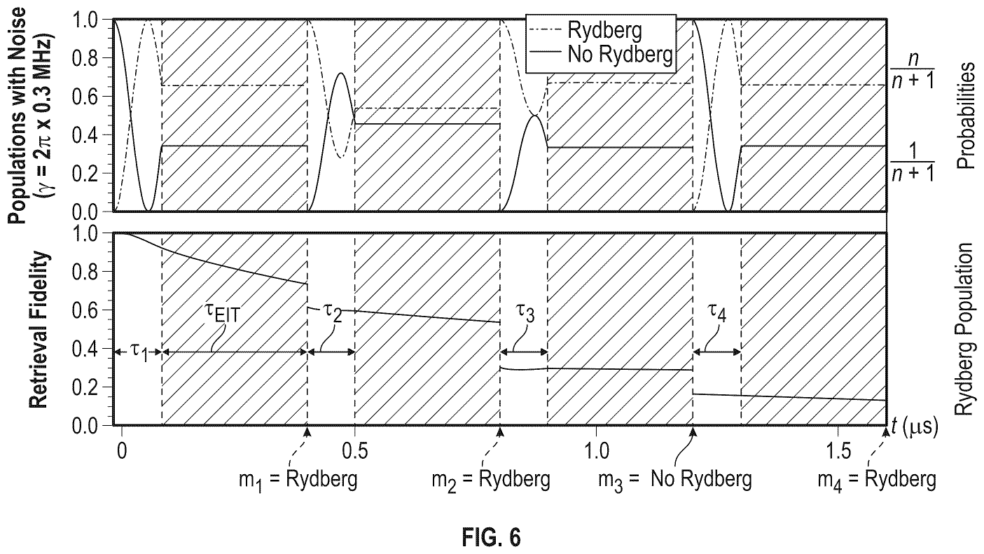

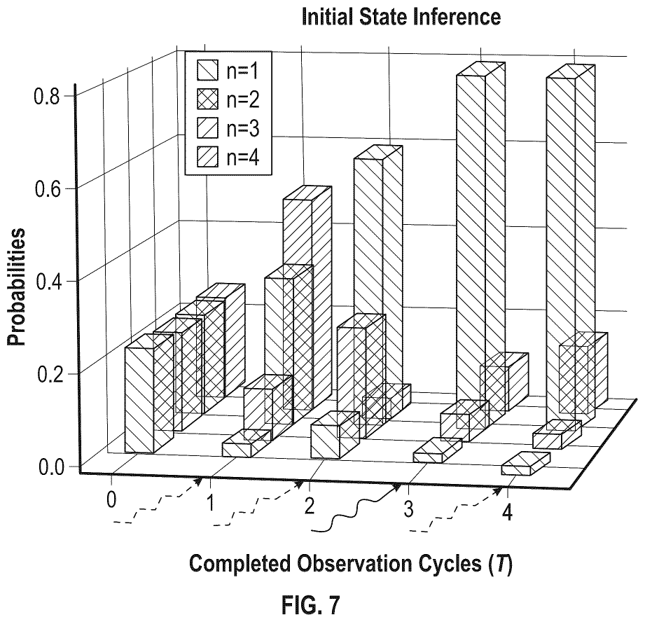

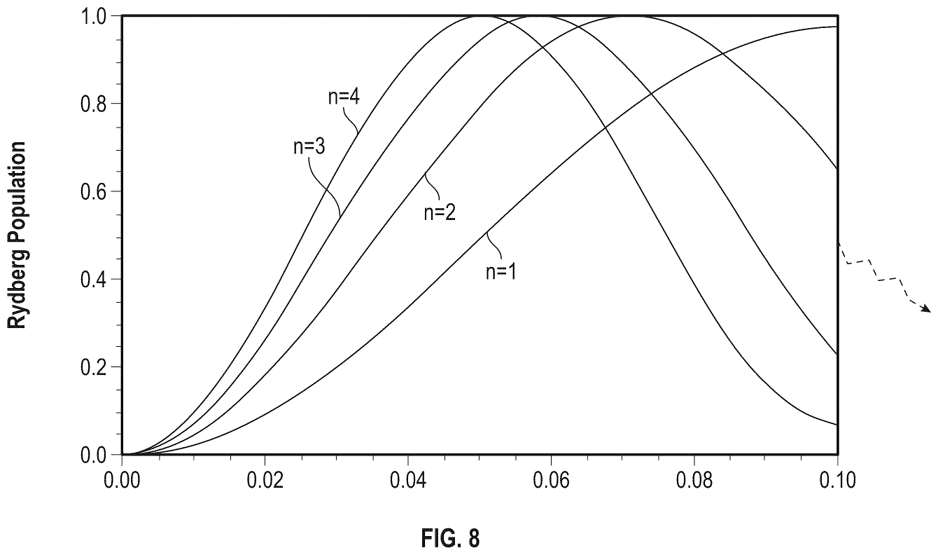

In the presence of noise, it is necessary to modify the likelihood Pr(M_{T}|n) appearing in the state inference to include dephasing. This reflects the fact that the goal is seeking to match observations with a different underlying signal. The likelihood in the presence of noise by Pr(M_{T}|n, γ) is denoted. As in the absence of noise, this quantity is a product: Pr(M_{T}|n, γ)=Π₍ₘ_{ᵢ}_{;t}_{ᵢ}_{)∈M}_{_{T}}Pr(mᵢ;tᵢ|n, γ). Pr(mᵢ;tᵢ|n, γ) can be calculated numerically (see FIG. 6), working in a truncated Hilbert space which, due to site permutation symmetry, is of dimension linear in n. This can be done in practice because the dephasing rate γ can be measured for a particular experimental realization of the quantum non-demolition photon counter 100 of FIG. 1 and therefore enters as a known parameter.

Within this noise model, the evolution of the system is particularly sensitive to the measurement outcome. When a Rydberg excitation is detected, the array is projected into the Rydberg sector, and further time evolution continues the approach of the system to its long-time steady state. In contrast, when no Rydberg excitation is detected, the decoherence between |r [symbol] and |s [symbol] is effectively reset. Going too long without measuring no Rydberg excitation leads to a weakened signal, which slows Fock state distillation and state inference. This slow-down can be avoided by ejecting the Rydberg atom when a Rydberg excitation is detected, returning the quantum system 300 to the no Rydberg sector of the Hilbert space with one fewer atom. In doing so, the detection time prevented from scaling as γn/Ω² rather than \sqrt{n}/Ω, at the cost of losing a number of photons throughout the quantum non-demolition photon counter 100 of FIG. 1.

In the regime where γ is large, oscillations rapidly decay, and frequency is no longer able to be used as a probe of photon number. However, the photon number is also imprinted on the steady-state values of the populations in the Rydberg and no Rydberg sectors, which are

$$\frac{n}{n + 1} and \frac{1}{n + 1} ,$$

respectively. These values emerge because the master equation drives the density matrix to the maximally mixed state in the Fock basis, which has n Rydberg states for each no Rydberg state. The steady-state populations are captured by Pr(M_{T}|n, γ), so no modifications to the state inference procedure are necessary to probe this signal. However, this signal is much weaker than the frequency signal, with detection time scaling as n³/γ. The detection is also no longer QND as the atomic state will have largely decohered.

To proceed quantitatively, the Fisher information

$${F}_{n} ( t ) = 𝔼 [ {( \frac{\partial }{\partial n} log f ( t ; n ) )}^{2} ]$$

is considered, where f(t; n) stands for the various signals—noiseless oscillation frequency, noisy oscillation frequency, and steady-state populations—from which parameter n can be infered. In this case, there are two possible measurement outcomes Rydberg and no Rydberg, so that:

$${F}_{n} ( t ) = {f}_{{m}_{i} \neq {m}_{i - 1}} ( t ; n ) {( \frac{\partial }{\partial n} log {f}_{{m}_{i} \neq {m}_{i - 1}} ( t ; n ) )}^{2} + {f}_{{m}_{i} = {m}_{i - 1}} ( t ; n ) {( \frac{\partial }{\partial n} log {f}_{{m}_{i} = {m}_{i - 1}} ( t ; n ) )}^{2} .$$

The subscript denotes whether the probability is that of measuring the same or opposite outcome as that previously measured. Detection time t_{*} is defined via Fₙ(t_{*)}=1, as this is when there is sufficient information to discern n from n+1.

In the absence of noise, there is fₘ_{ᵢ}₌ₘ_{_{i−1}}(t;n)=cos² (\sqrt{n}Ωt) and fₘ_{ᵢ}_{≠tm}_{_{i−1}}(t;n)=sin² (\sqrt{n}Ωt). Using these values, it is found that Fₙ(t)=t²Ω²/n so that t_{*}=\sqrt{n}/Ω in the absence of noise.

In order to approximate the convergence time in the presence of noise, it is assumed that the signal can be approximated as noiseless, so long as the measurement is performed in a short time relative to the inverse of the dephasing rate T=1/γ. In practice, a time αT would be chosen where α<1 is a positive constant, but here T is used because only the scaling behaviors are of interest. Once again for a single measurement Fₙ(T)=T²Ω²/n is found. However, in time t, t/T measurements are able to be made. To account for this, multiply by a shot noise factor t/T=tγ. Fₙ(t)=t_{*}Ω²/γn is then found so that t_{*}=γn/Ω² in the presence of noise.

Finally, the case in which γ is large and there is only access to the signal imprinted on the steady-state populations, rather than on the oscillation frequency, is considered. In this case, it is preferred to wait long enough to approximately approach the steady-state populations before making each measurement. The characteristic time scale is still T, though in this casea time αT is chosen where α>1 in practice. Once again, this time is taken to be T to capture the scaling behavior. The signal in this case is fₛ(t;n)=1/(n+1) and f_{R}(t;n)=n/(n+1), where the subscripts correspond to no Rydberg and Rydberg because the signal is a function of the current measurement outcome only, not the previous. In this case, it is found that Fₙ(T)=1/n(n+1)². Multiplying by the shot noise factor tγ yields Fₙ(t)=tγ/n(n+1)² and t_{*}=n(1+n)²/γ about n³/γ.

Next, two example implementations, of the quantum non-demolition photon counter 100 of FIG. 1, in ytterbium (Yb) atoms trapped in an array of optical tweezers will be described. Yb is a particularly attractive atomic platform because it has a long wavelength telecom transition and because trapping of its Rydberg states in the same tweezer as the ground state has been recently demonstrated, extending trap lifetimes to between about 50 μs to about 100 μs.

One of the implementations studied uses ¹⁷¹ Yb, and the other ¹⁷⁴ Yb. These implementations only differ in the states assigned to |g [symbol] and |s [symbol] . In ¹⁷¹Yb, |g [symbol] and |s [symbol] are assigned to two hyperfine ³P₀ states: |g [symbol] :=|³P₀,↓ [symbol] and |s [symbol] :=|³P₀,↑), where the arrow represents the nuclear spin. In ¹⁷⁴Yb, they are assigned to two members of the ³P_{J} triplet: |g [symbol] :=|³P₀ [symbol] and |s [symbol] :=|³P₂).

In both implementations, |e [symbol] :=|³D₁ [symbol] is assigned, making use of the ³P₀↔³D₁ telecom transition referenced above, which is approximately 1.4 μm. This wavelength, λ_{eg}, sets an upper bound on the array spacing d. Choosing levels such that λ_{eg} is large therefore allows for larger tweezer spacing without sacrificing efficiency. The Rydberg levels are assigned as |r [symbol] :=|6sns³S₁ [symbol] and |r′ [symbol] :=|m′pn′s³Pⱼ [symbol] , where m′, n′ and J are chosen to maximize the matrix element from |s [symbol] while avoiding dipole-dipole population exchange between |r [symbol] $ and |r′ [symbol] .

There is a potential complication to using hyperfine states in ¹⁷¹Yb for photon storage. Hyperfine structure opens the possibility of atoms decaying to multiple ground states, thus weakening the subradiance which underpins much of the valuable physics hosted by ordered arrays. Maximal subradiance can be (at least partially) restored by applying large Zeeman shifts, or potentially by engineering patterns of entanglement in the many-body states which suppress emission which is not subradiant.

Referring to FIG. 5, a flow diagram for a method for quantum non-demolition photon counting in accordance with the present disclosure is shown as 500. Although the steps of FIG. 5 are shown in a particular order, the steps need not all be performed in the specified order, and certain steps can be performed in another order. For example, FIG. 5 will be described below, with a controller 200 of FIG. 2 performing the operations. In aspects, the operations of FIG. 5 may be performed all or in part by another device, for example, a server, a mobile device, such as a smartphone, and/or a computer system. These variations are contemplated to be within the scope of the present disclosure.

Next, at step 504, the processor causes the system 100 to store the photon(s) in the array of atoms in a |g [symbol] −|e [symbol] transition using a classical control field acting on an |s [symbol] −|e [symbol] transition, where |s [symbol] is a metastable shelving state. Photons are converted to atomic excitations in the process of photon storage. In particular, a quantum state with one photon and an atom in its ground state is converted to a quantum state with zero photons and an atom in the intermediate (non-Rydberg) excited state. The array 310 of atoms is initially in a ground state |g [symbol] . The storage may be performed by sending the initial photonic state through a beamsplitter so that the initial photonic state is normally incident upon the array symmetrically from both sides. For example, the atoms are in an ordered, uniform, equally spaced-out lattice.

In aspects, the processor may cause system 100 to provide an excitation to put atoms of the array in an intermediate state. The intermediate state is intermediate between the ground state and the Rydberg state.

Next, at step 506, the processor causes the system 100 to oscillate the array between the states |s [symbol] and |r [symbol] , wherein |r [symbol] is a Rydberg state. For example, the oscillations may be driven by a laser.

Next, at step 508, the processor causes the system 100 to perform a projective measurement of a presence of a Rydberg excitation. The projective measurement may be performed by indirectly and progressively measuring a photon number n by directly and repeatedly measuring the presence of the Rydberg excitation after evolution under A for a predetermined period of time. For example, the projective measurements project the array into a subspace with or without a Rydberg excitation in |r), conditioned on the outcome of the measurement.

In aspects, the processor may cause the system 100 to perform the measurement by tuning to electronically induced transparency (EIT) and applying a weak classical probe light.

For example, the system 100 may apply EIT to the array in the Rydberg state, apply a classical probe light at the array; and determine if the array is transparent. In the absence of a Rydberg excitation, an EIT condition is satisfied and the array is transmissive. In the presence of the Rydberg excitation the EIT condition is disrupted and the array is reflective.

In aspects, the processor may cause the system 100 to retrieve the stored photons. In aspects, the array must be in the state |Sₙ [symbol] to retrieve the photons.

In summary, a noise-resilient quantum non-demolition photon counter 100 of FIG. 1 to non-destructively count arbitrary numbers of free space photons using an ordered array of Rydberg atoms is presented. It is shown that this quantum non-demolition photon counter 100 of FIG. 1 is effective in distilling arbitrary pure and mixed initial states to a single Fock state and in performing initial state inference. Within the analysis, the overall efficiency of the quantum non-demolition photon counter 100 of FIG. 1 is limited by the storage and retrieval efficiencies as well as dephasing during the observation stage. The quantum non-demolition photon counter 100 of FIG. 1 provides the technical benefit of significantly suppressing the storage and retrieval errors in this array geometry, as well as the dephasing errors. The quantum non-demolition photon counter 100 of FIG. 1 provides a technical solution ofperforming a projective measurement of a presence of a Rydberg excitation by indirectly and progressively measuring a photon number n by directly and repeatedly measuring the presence of the Rydberg excitation after evolution under A for a predetermined period of time to the technical problem of destroying photons when counting the photons.

It is contemplated that the system 100 may use a disordered atomic ensemble without significant changes to the system 100. However, disordered ensembles do not enjoy the strongly enhanced storage and retrieval efficiencies of ordered arrays. A disordered ensemble with a relatively high optical depth per blockade radius (ODb) of about 10 to 12 has an optimal combined storage and retrieval efficiency of about 50%, compared to an array of 16=4×4 atoms with an optimal combined storage and retrieval efficiency above 98%. It could however be beneficial to consider the experiment taking place in a cavity instead of in free space. This could further enhance the storage and retrieval efficiency of the array or even make disordered ensembles a more viable experimental platform.

In aspects, the system 100 may be used to further enable photonic density matrix tomography. Because displaced Fock states are tomographically complete, one would only need to introduce the additional operation of displacements in phase space, given by

$$D ( α ) = {e}^{α {\hat{α}}^{† - {α}^{*} \hat{α}}} where {\hat{α}}^{†} = {\sum }_{n} \sqrt{n + 1} \vert {S}_{n + 1} 〉 〈 {S}_{n} \vert .$$

This can be implemented on the stored excitations in the quantum non-demolition photon counter 100 of FIG. 1 via the couplings

$${\hat{H}}_{x} = Ω {\sum }_{j} {\hat{σ}}_{s , g}^{( j )} + {\hat{σ}}_{g , s}^{( j )} \approx Ω \sqrt{N - n} ( {\hat{α}}^{†} - \hat{α} ) and$$

$${\hat{H}}_{y} = i Ω {\sum }_{j} {\hat{σ}}_{s , g}^{( j )} + {\hat{σ}}_{g , s}^{( j )} \approx i Ω \sqrt{N - n} ( {\hat{α}}^{†} - \hat{α} ) ,$$

where the second equality in each holds in the limit N−n>>1. Any D(α) can be implemented by successively applying Ĥₓ for time tₓ and Ĥ_{y} for time t_{y}, with α=Ω\sqrt{N−n}(itₓ−t_{y}).

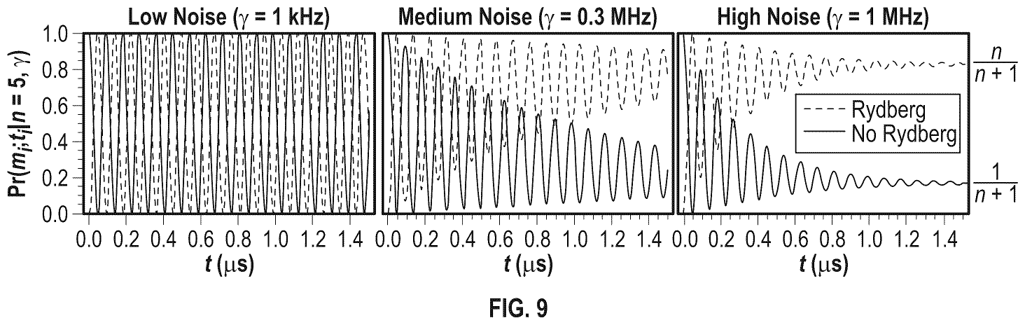

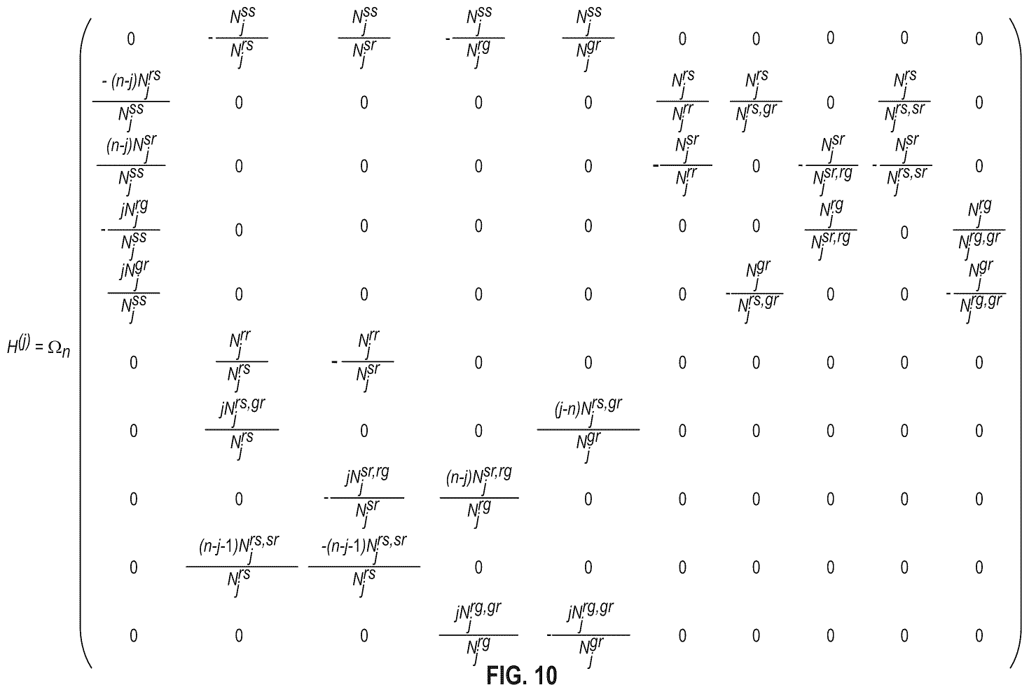

Referring to FIGS. 9-11, an efficient numerical algorithm for use with the system 100 is described. A construction of the truncated basis may be used to efficiently solve the many-body problem defined by the master equation:

$$\dot{ρ} ( t ) = - i [ \hat{H} , ρ ] + γ ( {\sum }_{i} {\hat{n}}_{i} ρ {\hat{n}}_{i} - \frac{1}{2} ( {\hat{n}}_{i} , ρ \} ) ,$$

$$where \hat{H} = Ω {\sum }_{i = 1}^{N} {\hat{σ}}_{rs}^{( i )} + h . c . and {\hat{n}}_{i} := \vert {r}_{i} 〉 〈 {r}_{i} \vert .$$

In order to solve this equation numerically, the Lindbladian

$$L [ \cdot ] = - i [ \hat{H} , \cdot ] + γ ( {\sum }_{i} {\hat{n}}_{i} \cdot {\hat{n}}_{i} - \frac{1}{2} \{ {\hat{n}}_{i} \cdot \} )$$

is written down as a superoperator [symbol] [·]=: i [symbol] [·]+γ [symbol] [·] in an efficiently constructed basis. It will be found that the size of this basis grows linearly in n, which is taken to be fixed. The notation of, where density matrices are written as superkets with double brackets |φ [symbol] =Σ_{i,j}ρᵢⱼ|i [symbol] j|, superbras are defined as [symbol] μ|=|μ [symbol] ^{†}, and the inner product is given by [symbol] u|v [symbol] =Tr[u^{†}v].

The goal is to find the matrix forms [symbol] and [symbol] of the superoperators, where [symbol] _{μv}: = [symbol] μ| [symbol] |v [symbol] and similarly for [symbol] _{μv}. To do this, symmetry of the Lindbladian is exploited. The initial state |S [symbol] S| is symmetric under permutation of the atomic sites, and [symbol] respects this symmetry, so the basis can be restricted to only permutation-symmetric states. It can further be recognized that both the initial state and the Lindbladian are symmetric with respect to

$${gg}_{} := {\sum }_{i = 1}^{N} {\hat{σ}}_{gg}^{( i )} ,$$

in the sense that [symbol] _{gg}|S [symbol] S|=|S [symbol] S| and [ [symbol] _{gg}, Ĥ]=[ [symbol] _{gg}, \hat{n}ᵢ]=0. The ability to block diagonalize [symbol] in terms of the \hat{σ}_{gg} population is allowed. Where the sum is over permutations of the on-site density matrices across sites and \hat{σ}_{μv}:=|μ [symbol] v|·j=0, . . . , n indexes the blocks of the Hamiltonian superoperator

$$= {⊕}_{j = 0}^{n} {( j )}^{}$$

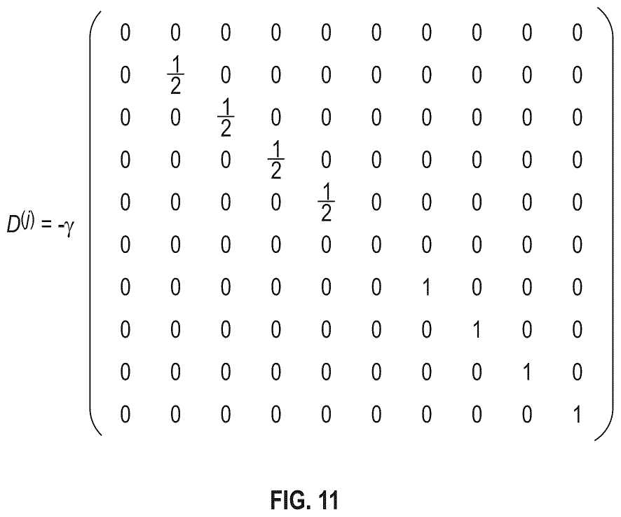

and the [symbol] are normalization constants such that [symbol] ρᵢ|ρᵢ [symbol] =1. This basis also diagonalizes [symbol] _{μv} entirely.

[symbol] can be explicitly expressed in terms of the normalization coefficients of the basis states as shown in FIG. 11. Because the truncated basis diagonalizes [symbol] , there is a particularly simple matrix representation of [symbol] ^{(j)} (FIG. 12).

$${T}_{} = {\sum }_{{M}_{T}} {max}_{{P}_{α}} Pr ( {M}_{T} \vert {P}_{α} ) Pr ( {P}_{α} )$$

Notice that the only populations in ρ are given by

$$\vert {ρ}_{0}^{ss} ≫ \vert {ρ}_{0}^{rr} ≫ .$$

It is therefore only necessary to solve for the dynamics in the j=0 block of ρ in order to calculate Pr(M_{T}|n, γ). The master equation is numerically solved for n=5 and N=10 and a variety of dephasing rates γ, the results of which are displayed in FIG. 9.

Measurement dynamics of the quantum non-demolition photon counter 100 of FIG. 1 are insensitive to coherences between states of different photon number. Consider the evolution of the density matrix of the system p under the unitary dynamics generated by Ĥ_{coll}, governed by the master equation \dot{ρ}(t)=−i[Ĥ_{coll}, ρ]. These dynamics do not couple states with different photon numbers, which implies the insensitivity to coherences of the dynamics of the populations. This means that the populations of two initial density matrices with the same populations and different coherences will evolve in the same way under the quantum non-demolition photon counter 100 of FIG. 1. In particular, this implies that the populations of any density matrix will evolve in the same way as the diagonal density matrix with the same populations. This has two implications.

First, it explains why it is not possible to choose drive times τᵢ which steer the state of the system toward a particular photon number state. Because the evolution of the populations is indistinguishable from that of a classical mixture ρ_{class}=ΣₙPₙ|n [symbol] n|, the dynamics serve to distill the state |n [symbol] with probability pₙ=|cₙ|², regardless of the measurement pattern chosen. However, different measurement patterns may lead to faster convergence to |n [symbol] .

Second, it implies that the path to convergence recorded in the measurement record does not directly encode any information beyond the final value to which the quantum non-demolition photon counter 100 of FIG. 1 converged. This is because the populations evolve as if the density matrix were a classical mixture, so the measurement dynamics are consistent with a single |n [symbol] being sampled from this distribution at the beginning of the quantum non-demolition photon counter 100 of FIG. 1. However, it is still possible to learn something about the initial populations of other number states via the prior. As an example, consider a uniform prior taken over P₁=(0,0.9,0.1) and P₂=(0,0.1,0.9). If an experiment converges to n=1, it is known that P₁ is more likely and therefore it is likely that there was little initial population in n=2, even though all that was directly measured was that there was initially some population in n=1.

Below it is illustrated through a minimal example that optimizing the drive times {τᵢ} is exponentially difficult. In order to precisely define the optimal strategy for choosing drive times {τᵢ}, it is necessary to first fix a figure of merit. Considered here is the accuracy of the initial state inference as given by the maximum likelihood estimate (MLE) generated by the measurement record. The expected value of the MLE over experimental realizations is called the fidelity and denoted by [symbol] . More explicitly, for a set of potential initial photon number distributions {P_{α}}_{N} and T observation cycles, there is

$${T}_{} = {\sum }_{{M}_{T}} {max}_{{P}_{α}} Pr ( {M}_{T} \vert {P}_{α} ) Pr ( {P}_{α} ) .$$

It is natural to consider whether a local-in-time strategy—that is, choosing each τᵢ independently to maximize each [symbol] ᵢ—might yield a globally optimal set of times {τᵢ}_{i=1, . . . ,T} with respect to the fidelity after some fixed number T of observation cycles, [symbol] _{T}. This task is appropriate for the regime in which the measurement time is large compared to the standard deviation of the oscillation time, so that a fixed number of observation cycles approximately corresponds to fixed total time. It has been demonstrated numerically that such a local strategy is not in general optimal.

In a toy state discrimination task wherein the quantum non-demolition photon counter 100 of FIG. 1 had two observation cycles (T=2) to distinguish between two potential initial states

$${P}_{1} = ( 0 , \frac{1}{3} , \frac{1}{3} , 0 , \frac{1}{3} , 0 )$$

and P₂=(0,0,0,1,0,0), the local strategy led after the first cycle—

$${1}_{loca1}^{} = 96.59 \% , {1}_{global}^{} = 96.52 \%$$

—but was overtaken in the second cycle—

$${1}_{local}^{} = 99.84 \% , {1}_{global}^{} = 99.89 \% .$$

This demonstrates that allowing for τᵢ which yield suboptimal values of intermediate [symbol] ᵢ avails measurement patterns with higher values of [symbol] _{T} at the conclusion of the quantum non-demolition photon counter 100 of FIG. 1, so that the local-in-time strategy is not optimal. However, these differences can be quite small, as in this toy example.

For a set number of observation cycles T, the optimal strategy—that which maximizes [symbol] _{T}—can still in principle be evaluated numerically. However, the absence of an optimal local-in-time strategy implies that the cost of finding the globally optimal strategy grows exponentially in the number of observation cycles T.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the present disclosure and may be embodied in various forms. For example, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the drawings.

The phrases “in an aspect,” “in aspects,” “in various aspects,” “in some aspects,” or “in other aspects” may each refer to one or more of the same or different example aspects provided in the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the present disclosure. Other elements, steps, methods, and techniques that are insubstantially different from those described above and/or in the appended claims are also intended to be within the scope of the present disclosure.

What is claimed is:

1. A system for quantum non-demolition photon counting comprising:
a quantum system including photons;
a processor; and
a memory, including instructions stored thereon, which, when executed by the processor, cause the system to:
store photon(s) in an array of atoms of the quantum system using a classical control field acting on an |s [symbol] -|e [symbol] transition, wherein |s [symbol] is a metastable shelving state and |e [symbol] is an excited state, wherein the array of atoms is initially in a ground state |g [symbol] ;
oscillate the array between the states |s [symbol] and |r [symbol] , wherein |r [symbol] is a Rydberg state; and
perform a projective measurement of a presence of a Rydberg excitation by indirectly and progressively measuring a photon number n by directly and repeatedly measuring the presence of the Rydberg excitation after evolution under Ĥ for a predetermined period of time.

2. The system of claim 1, wherein the array is a Rydberg array, wherein the atoms are in an ordered, uniform, equally spaced-out lattice.

3. The system of claim 1, wherein the projective measurements project the array into a subspace with or without a Rydberg excitation in |r [symbol] , conditioned on the outcome of the measurement.

4. The system of claim 1, wherein the instructions, when executed by the processor, further cause the system to:
provide an excitation to put atoms of the array in an intermediate state.

5. The system of claim 1, wherein the oscillations are driven by a laser.

6. The system of claim 1, wherein only the atoms that have absorbed photons are addressed by driving the atoms that have absorbed photons to a Rydberg state.

7. The system of claim 1, wherein the instructions, when executed by the processor, further cause the system to:
determine the photon number n based on increasing the oscillation frequency from a first frequency to a second frequency.

8. The system of claim 1, wherein the instructions, when executed by the processor, further cause the system to:
send the initial photonic state through a beamsplitter so that the initial photonic state is normally incident upon the array symmetrically from both sides.

9. The system of claim 1, wherein the instructions, when executed by the processor, further cause the system to:
retrieve the stored photons, wherein the array must be in the state |Sₙ [symbol] to retrieve the photons.

10. The system of claim 1, wherein the measurement is performed by tuning to electronically induced transparency (EIT) and applying a weak classical probe light, and
wherein the instructions, when executed by the processor, further cause the system to:
apply EIT to the array in the Rydberg state;
apply a classical probe light at the array; and
determine if the array is transparent,
wherein in the absence of a Rydberg excitation, an EIT condition is satisfied and the array is transmissive, and
wherein in the presence of the Rydberg excitation the EIT condition is disrupted and the array is reflective.

11. A method for quantum non-demolition photon counting, the method comprising:
storing photon(s) in an array of a quantum system using a classical control field acting on an |s [symbol] -|e [symbol] transition, wherein |s [symbol] is a metastable shelving state and |e [symbol] is an excited state, wherein the array of atoms is initially in a ground state |g [symbol] ;
oscillating the array between the states |s [symbol] and |r [symbol] , wherein |r [symbol] is a Rydberg state; and
performing a projective measurement of a presence of a Rydberg excitation by indirectly and progressively measuring a photon number n by directly and repeatedly measuring the presence of the Rydberg excitation after evolution under Ĥ for a predetermined period of time.

12. The method of claim 11, wherein the array is a Rydberg array, wherein the atoms are in an ordered, uniform, equally spaced-out lattice.

13. The method of claim 11, wherein the projective measurements project the array into a subspace with or without a Rydberg excitation in |r [symbol] , conditioned on the outcome of the measurement.

14. The method of claim 11, further comprising:
providing an excitation to put atoms of the array in an intermediate state.

15. The method of claim 11, wherein only the atoms that have absorbed photons are addressed by driving the atoms that have absorbed photons to a Rydberg state.

16. The method of claim 11, further comprising:
determining the photon number n based on increasing the oscillation frequency from a first frequency to a second frequency.

17. The method of claim 11, further comprising:
sending the initial photonic state through a beamsplitter so that the initial photonic state is normally incident upon the array symmetrically from both sides.

18. The method of claim 11, further comprising:
retrieving the stored photons, wherein the array must be in the state |Sₙ [symbol] to retrieve the photons.

19. The method of claim 11, wherein the measurement is performed by tuning to electronically induced transparency (EIT) and applying a weak classical probe light, and
wherein the method further comprises:
applying EIT to the array in the Rydberg state;
applying a classical probe light at the array; and
determining if the array is transparent,
wherein in the absence of a Rydberg excitation, an EIT condition is satisfied and the array is transmissive, and
wherein in the presence of the Rydberg excitation the EIT condition is disrupted and the array is reflective.

20. A non-transitory computer-readable medium storing instructions which, when executed by a processor, cause the processor to perform a computer-implemented method for quantum non-demolition photon counting, the method comprising:
storing photon(s) in an array of a quantum system using a classical control field acting on an |s [symbol] -|e [symbol] transition, wherein |s [symbol] is a metastable shelving state and |e [symbol] is an excited state, wherein the array of atoms is initially in a ground state |g [symbol] ;
oscillating the array between the states |s [symbol] and |r [symbol] , wherein |r [symbol] is a Rydberg state; and
performing a projective measurement of a presence of a Rydberg excitation by indirectly and progressively measuring a photon number n by directly and repeatedly measuring the presence of the Rydberg excitation after evolution under Ĥ for a predetermined period of time.
